(19) United States
(12) Patent Application Publication
(10) Pub. No.: US 2021/0270416 A1
(43) Pub. Date: Sep. 2, 2021

(54) Kinematic Mirror Mount Adjustment System

(71) Applicant: Photon Valley, Inc., Lake Forest, CA (US)

(72) Inventors: James Campbell, Foothill Ranch, CA (US); Christopher Guerrero, Laguna Niguel, CA (US); Daniel Castro, Lake Forest, CA (US)

(21) Appl. No.: 16/805,109

(22) Filed: Feb. 28, 2020

(51) Int. Cl. F16M 13/02; G02B 7/182

(52) U.S. Cl. CPC F16M 13/022; G02B 7/182

(57) ABSTRACT

Kinematic mounts are used frequently to hold objects such as mirrors, lenses, and other optical equipment. To adjust kinematic mounts, adjustment mechanisms are often required. Adjustment mechanisms can be used to make fine adjustments in applications where precision is required (e.g., laser system prototyping). Kinematic mounts that include never-before implemented form factors and structural elements require new adjustment solutions, and those solutions are described in this application. Adjustment mechanisms described in this application include a main body, a control frame, and control screws to adjust the orientation of the control frame. The control frame is coupled with a kinematic mount's housing, which rotates about a center of curvature of a bottom surface of the housing.

### FIELD OF THE INVENTION

The field of the invention is kinematic mount adjustment mechanisms.

### BACKGROUND

The background description includes information that may be useful in understanding the present invention. It is not an admission that any of the information provided in this application is prior art or relevant to the presently claimed invention, or that any publication specifically or implicitly referenced is prior art.

In the space of kinematic mounts for, e.g., mirrors or other optics equipment, innovation has been slow or nonexistent for many years. Few have approached this field with novel new thoughts or ideas on how kinematic mounts and their associated position and orientation adjustment mechanisms can be reinvented. Though many have improved on the current state of adjustment mechanisms over the years, none have reimagined the kinematic mount that those adjustment mechanisms work with. There therefore remains a need to develop improved kinematic adjustment mechanisms that account for a completely different type of kinematic mount.

In U.S. Pat. No. 6,765,733 to Igl et al., for example, a laser mounting system is contemplated that includes several ball and socket joints with an associated adjustment system. The physical structure of the device in the '733 patent fails to consider a reimagined kinematic mount, and thus fails to solve problems associated with new types of kinematic mounts that operate on fundamentally different bases than the state of the art. U.S. Pat. No. 9,329,028 to Bridges et al. describes mirror mounting systems having spherical or semispherical mounts, but because this patent again fails to contemplate new kinematic mounts that do not share many—if any—overlapping features with kinematic mounts as they currently exist.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

It has yet to be appreciated that kinematic mounts can be reimagined using completely different structural elements than the prior art contemplates. With new types of kinematic mounts come new needs for adjustment mechanisms, and the prior art similarly leaves open a need for kinematic mount adjustment mechanisms to facilitate adjusting position and orientation of new kinematic mounts.

Thus, there is still a need in the art for improved kinematic mount adjustment mechanisms.

### SUMMARY OF THE INVENTION

The present invention provides apparatuses, systems, and directed to adjustment mechanisms for kinematic mounts. In one aspect of the inventive subject matter, a kinematic mount adjustment mechanism comprises: a main body having a mounting frame; a control frame; a first control screw that contacts a main body surface at an end of the first control screw; and a second control screw oriented orthogonally to the first control screw and that contacts a mounting frame surface at an end of the second control screw. The mounting frame surface is orthogonal to the main body surface, the first control screw couples with the control frame by passing through a first screw harness that is coupled with the control frame, and the second control screw couples with the control frame by passing through a second screw harness that is also coupled with the control frame.

In some embodiments, the control frame is configured to couple with a kinematic mount. The first and second screw harnesses can include internal threading. In some embodiments, the system additionally includes a first spring and a second spring, where the first spring pulls the control frame toward the main body and the second spring pulls the control frame toward a second spring mount that is affixed to the main body. The first spring can be oriented to affect movement caused by turning the first control screw, and the second spring can be oriented to affect movement caused by turning the second control screw.

In some embodiments, the main body surface comprises an elongated divot for the end of the first control screw to move within upon turning the second control screw. The mounting frame surface can similarly include an elongated divot for the end of the second control screw to move within upon turning the first control screw. In some embodiments, the first screw harness is moveably coupled with the control frame.

In another aspect of the inventive subject matter, a kinematic mount adjustment mechanism comprises: a main body having a mounting frame; a control frame; a first control screw that contacts a main body surface at an end of the first control screw; and a second control screw oriented orthogonally to the first control screw and that contacts a mounting frame surface at an end of the second control screw. The mounting frame surface is orthogonal to the main body surface, the first control screw couples with the control frame by passing through a first screw harness that is coupled with the control frame, and the second control screw couples with the control frame by passing through a second screw harness that is also coupled with the control frame. It also includes a first spring that couples with the control frame and with a first spring mount such that the first spring pulls the control frame toward the main body and a second spring that couples with the control frame and with a second spring mount that is affixed to the main body such that the second spring pulls the control frame toward the second spring mount.

In some embodiments, the control frame is configured to couple with a kinematic mount. The first and second screw harnesses can include internal threading, and the main body surface can have an elongated divot for the end of the first control screw to move within upon turning the second control screw. The mounting frame surface can similarly include an elongated divot for the end of the second control screw to move within upon turning the first control screw. In some embodiments, the first screw harness is moveably coupled with the control frame. The system can additionally include a countersunk cutout in the main body to facilitate mounting the main body to a surface.

One should appreciate that the disclosed subject matter provides many advantageous technical effects including an entirely new adjustment mechanism that is designed to function with kinematic mounts that pivot about a center point.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of an adjustment mechanism with an attached kinematic mount.

FIG. 2 is a perspective view of the adjustment mechanism without an attached kinematic mount.

FIG. 3 is an alternative perspective view of the adjustment mechanism.

FIG. 4 is a left-side view of the adjustment mechanism.

FIG. 5 is a right-side view of the adjustment mechanism.

FIG. 6 is top view of the adjustment mechanism.

FIG. 7 is a cutaway view of the adjustment mechanism.

FIG. 8 shows a bottom view of a portion of a main body of an adjustment mechanism.

FIG. 9 shows a close-up view of a control frame.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

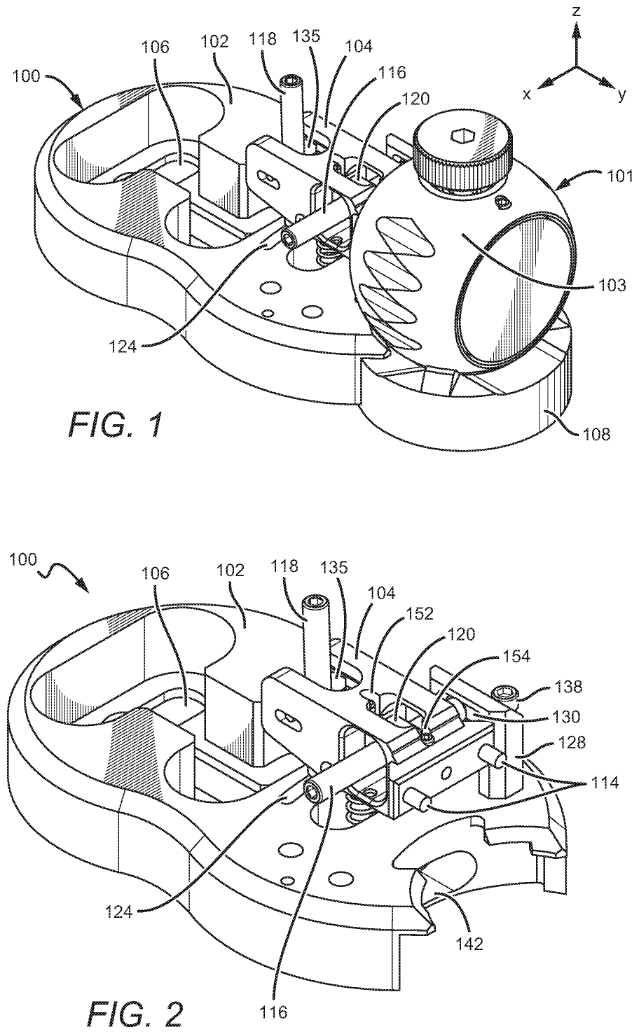

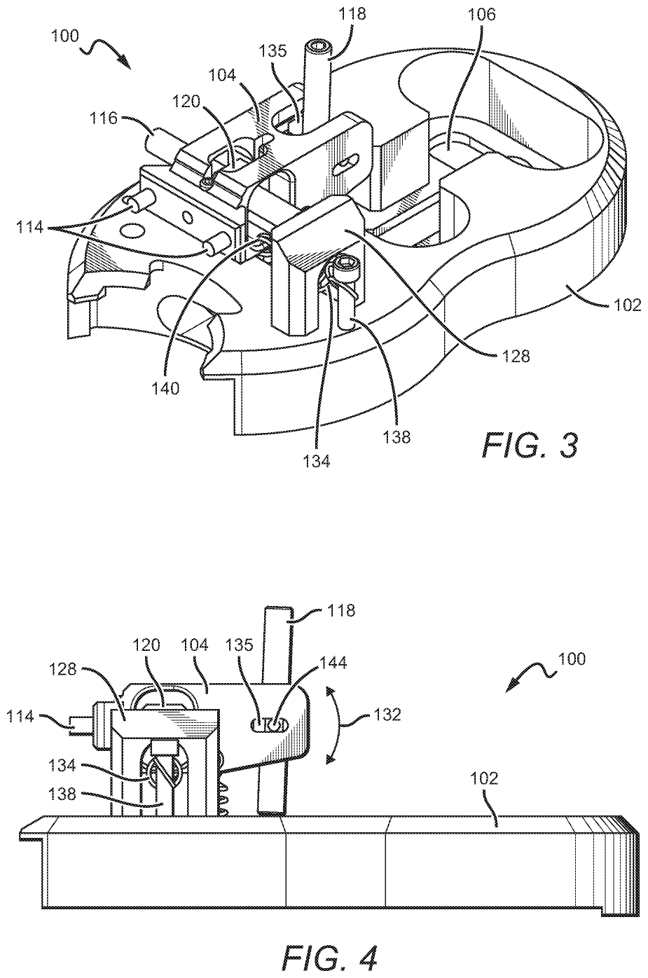

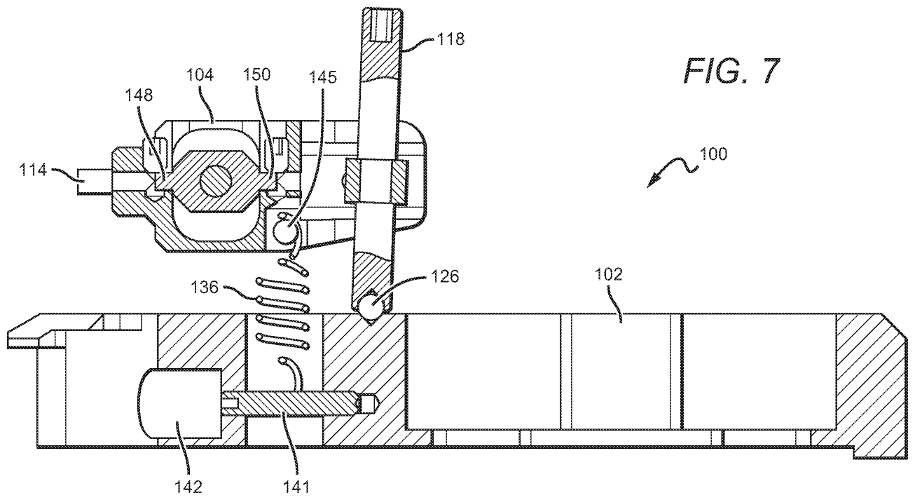

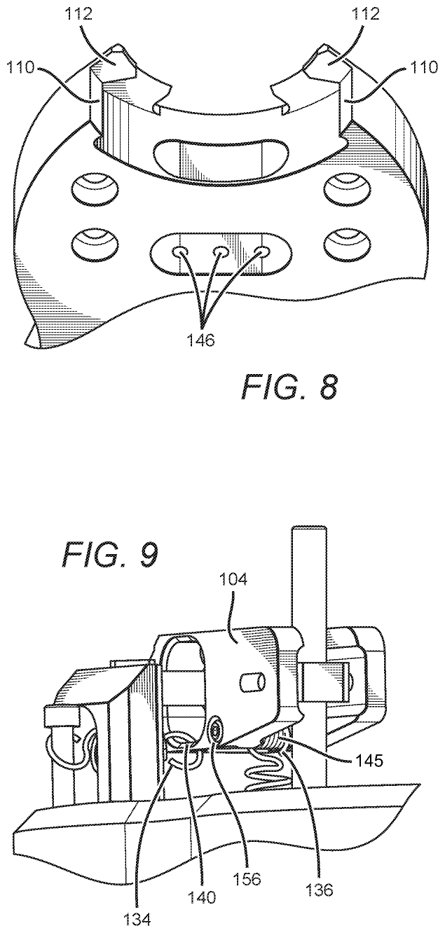

Adjustment mechanisms of the inventive subject matter are designed to control positioning and orientation of kinematic mirror mounts where the moveable aspect of the kinematic mirror mount rests on a curved surface and can be repositioned about a center of curvature of that curved surface. FIG. 1 shows a perspective view of an adjustment mechanism 100 of the inventive subject matter when it is coupled with a kinematic mirror mount 101. FIGS. 2-6 show the adjustment mechanism 100 without an attached kinematic mount, FIG. 7 shows a cutaway view of adjustment mechanism 100, FIG. 8 shows main body 102 from the underside, and FIG. 9 shows a close up of the control frame 104.

Adjustment mechanism 100 includes a variety of different components, including a main body 102 and a control frame 104. The main body 102 acts as a foundational component that allows the adjustment mechanism 100 to be coupled with, e.g., a prototyping board. The main body 102 features a countersunk cutout 106 that allow for screws or other fasteners to hold the main body 102 to a surface (e.g., a prototyping board or table). The cutout 106 shown in the figures is shaped like the capital letter I, though other configurations are also contemplated, including more than one cutout. The countersunk cutout 106 facilitates different orientations of the main body when it is fastened to a surface. It is countersunk so that the flared portion of, e.g., a machine screw can hold the main body down to a surface that the screw screws into.

While the overall shape of the main body need not take on any specific shape, the shape of the portion of the main body 102 that couples with the kinematic mount 101 should have a shape complementary to the shape of the kinematic mount's footing 108. FIG. 8 shows features of the mating portion of the main body 102. Main body 102 includes several features that contact the footing 108 of the kinematic mount 101. The mating portion includes two contact points 110 as well as two mating tabs 112. The two contact points 110 are formed with angled surfaces (e.g., curved) to match the curved surface of the footing 108. As shown in FIG. 8, contact points 110 are curved surfaces having a center of curvature that coincides with the center of curvature of the footing 108 when the footing 108 is mated with the main body 102. Contact points 110 are shown protruding from the surrounding material. This can help to hold the footing 108 stationary relative to the main body 102 by having the contact points fit into complementary slots, notches, or grooves on the footing. Mating tabs 112 are protrusions designed to help prevent the footing 108 from rotating relative to the main body 100 by their interactions with the footing 108 (e.g., friction interactions or by fitting into grooves on the footing). Holding the footing 108 stationary relative to the main body 102 ensures that the kinematic mount 101 can be adjusted accurately by the adjustment mechanism 100 without unwanted movements of the footing 108 relative to the main body 102.

Coupled with the main body 100 is the control frame 104. The control frame 104 also couples with the kinematic mount's housing 103 via two extrusions 114. Upon coupling the control frame 104 to the housing 103, the housing 103 and the control frame 104 move with one another such that causing the control frame 104 to move accordingly causes the housing 103 to move. This forms the basis of the adjustment mechanism's effectiveness, as the control frame 104 additionally features two control screws 116 & 118 that can be turned to change the position and orientation of the control frame 104, thereby also changing the position and orientation of the housing 103. Extrusions 114 can be machined from the same stock used to create the control frame, and, in some embodiments, extrusions 114 can alternatively be made from dowel pins or they can be screwed into the control frame.

The control frame 104, as mentioned above, features at least a first control screw 116 and a second control screw 118. Each of the control screws 116 & 118 can feature a hex head as shown in the figures or e.g., any other type of screw head to facilitate tool-assisted turning of the screws. In some embodiments, control screws can be hand-turned and feature, e.g., a textured surface to improve grip. Turning the first control screw 116 causes rotation of the housing 103 about the housing's z-axis as shown in FIG. 1. Notably, a reference frame associated with the housing (the x,y, and z-axes shown in FIG. 1) reorients with the housing 103. Thus, while the housing 103 is level relative to the main body (e.g., the mirror mounted within the housing faces straight ahead, as shown in FIG. 1), as the first control screw 116 is turned, the housing 103 rotates about only the z-axis with the other axes rotating with the housing 103 (e.g., such that they-axis always faces in the direction the housing is facing). The configuration of the control frame 104 and its associated control screws 116 & 118 give rise to rotation about any of the axes defined according to the position and orientation of the housing 103, making it possible to, e.g., reflect light shining onto the mirror mounted in the housing 103 in any direction by using the control screws 116 & 118 to adjust the housing's position and orientation.

Both the first control screw 116 and the second control screw 118 pass through screw harnesses 120 & 135 having internal threading (e.g., nuts that are fixed in place within the control frame 104). In some embodiments, the screw harnesses are formed as part of the control frame 104. The first screw harness 120 is held in place relative to the control frame 104 such that turning the first control screw 116 causes the control frame 104 to move as demonstrated by double-sided arrow 122 shown in FIG. 6 (e.g., rotation about the housing's z-axis). To facilitate movement according to line 122 while the second control screw 118 remains in contact with the main body 102, the main body 102 features an elongated curved divot 124 that a tip of the second control screw 118 rests within. It is contemplated that the first and second control screws 116 & 118 can be the same, each featuring, in some embodiments, a small magnet on one end. As shown in FIG. 7, second control screw 118 is shown with a magnet 126 on its tip. Magnet 126 helps to hold the second control screw 118 to the main body 102, e.g., such that the magnetic tip of the second control screw 118 remains in contact with the main body 102. In some embodiments, both control screws 116 & 118 can include ball bearings on their tips to make adjustment easier by reducing friction between each control screw and the surfaces their tips contact.

A similar elongated divot exists for the first control screw 116, where that elongated divot 130 is positioned on an upper portion of a mounting frame 128. The upper elongated divot 130 functions to keep the tip of the first control screw 116 within the upper elongated divot 130, thereby facilitating fine adjustment of the position and orientation of the housing 103 while it is coupled with the control frame 104. Thus, both elongated divots work to keep the control screws in contact with their respective components even when the control screws are turned to adjust the position and orientation of the control frame 104 and, accordingly, the housing 103.

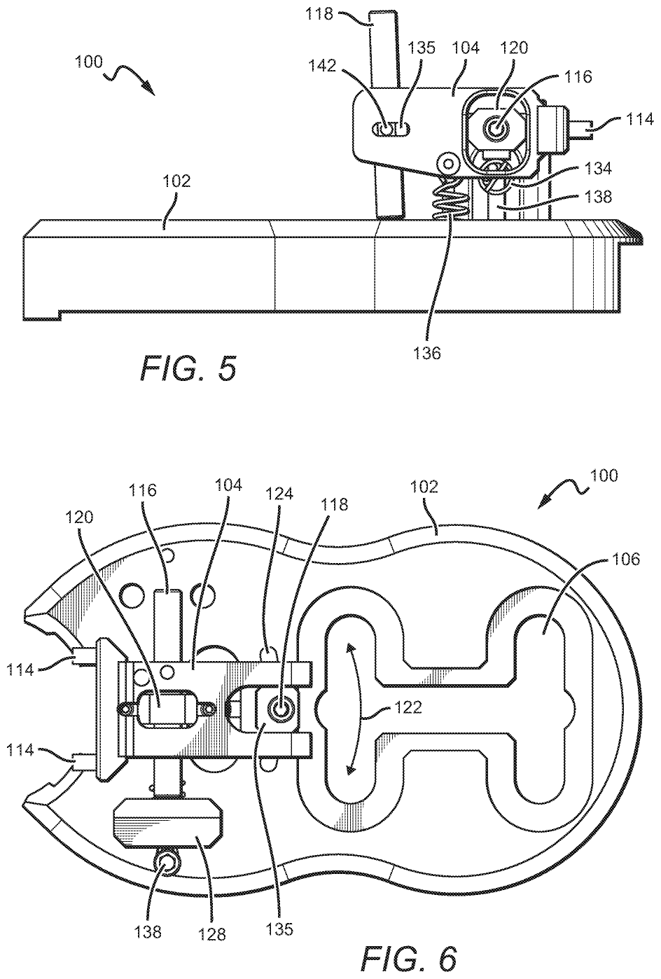

Like the first control screw 116, the second control screw 118 passes through a second screw harness 135. When the second control screw 118 is turned, it interacts with the second screw harness 135 causing movement of the control frame 104. Thus, turning the second control screw 118 causes the control frame to move according to double-sided arrow 132 (e.g., rotation about the housing's x-axis). To ensure control frame 104 can move according to movements of the housing 103 that it is coupled with (e.g., as shown in FIG. 1), screw harness 135 includes pegs on either side (peg 142 in FIG. 5 and peg 144 in FIG. 4) that rest within slots (a slot for peg 142 is visible in FIG. 5 and a slot for peg 144 is visible in FIG. 4) in the control frame 104. This allows for the second control screw 118 to tilt as it is turned, facilitating natural movements of the housing 103 despite being coupled with the control frame 104. In some embodiments, instead of or in addition to set screws, dowel pins can be used to hold pegs 142 & 144 in place.

Screw harness 120 also includes pegs 148 & 150 (visible in FIG. 7) that facilitate limited movement of the screw harness 120 within the control frame 104. As shown in FIG. 2, pegs 148 and 150 fit within slots 152 & 154 and are held in pace by set screws. This configuration allows for replacement or removal of the screw harness 120. It is contemplated that slots for pegs 142 and 144 can be cut through to the back end of the control frame, in which case set screws could be used to ensure screw harness 135 remains in place once it is coupled with the control frame 104. In some embodiments, instead of or in addition to set screws, dowel pins can be used to hold pegs 148 & 150 in place.

The control frame and associated components are designed such that changing the position and orientation of the housing can be accomplished such that the housing moves naturally within the footing. In other words, adjustment mechanisms of the inventive subject matter are designed to ensure that the control frame facilitates movement about a point of rotation that exists at the center of curvature of the curved bottom surface of the housing when it rests within the footing.

To minimize accidental movements of the control frame 104, the control frame 104 is held to the main body by a set of springs 134 & 136 that are held in tension. The first spring 134 couples with both the control frame 104 at a first spring mounting point 140 (e.g., a through hole or hooked portion) and with a first spring screw 138 that is coupled with the main body 102. In some embodiments, the first spring screw 138 can instead be formed with the main body 102 or as part of the mounting frame 128. The first spring 134 thus pulls the control frame 104 toward the first spring screw 138, thereby minimizing accidentally movements of the control frame.

As shown in FIG. 7, the second spring screw 141 is mounted within the main body 102 and provides an anchoring for the second spring 136. As seen best in FIG. 8, the second spring screw 141 can be disposed within any of the three screw slots 146 within the main body 102. Thus, the second spring 136, which is oriented substantially vertically, pulls the control frame 104 toward the second spring screw 141 when the second spring 136 couples with the third spring screw 145 and with the second spring screw 141. The third spring screw 145 can include a bar passing through the control frame 104 such that the second spring 136 can hook into the third spring screw 145. Although it is called a “spring screw” in this application, it can be fully, partially, or unthreaded, depending on the needs of an embodiment. In some embodiments, the third spring screw 145 is a dowel or pin dowel. The second spring screw is put into place and otherwise accessed by cutout 142 in the main body 102.

FIG. 9 shows a close-up view of control frame 104, showing how the second spring 136 couples with the control frame 104 by hooking onto a third spring screw 141. In some embodiments, the second spring 136 couples more directly with the control frame 104, such as hooking onto mounting point 156 or onto any other portion of the control frame 104 that can be used to facilitate spring coupling. Mounting point 156, as shown in FIG. 9, is also an access point for third spring screw 141, and, in some embodiments, includes a small hole near mounting point 156 that creates a place for a hooked end of a spring 141 to couple with.

As mentioned above, a mounting frame 128 is coupled with (or, e.g., formed with) the main body 102. The mounting frame 128 shown in the figures forms an upside-down u-shape. It is formed in this way so that, e.g., the first spring 134 can pass through it, coupling with both the first spring screw 138 and the first spring mounting point 140 located on the control frame 104. Alternative configurations are also contemplated, including a lambda shaped mounting frame or a T-shaped frame. In some embodiments, the first spring 134 couples with the mounting frame 128 instead of with the first spring screw 138.

Thus, specific adjustment mechanisms for use in association with kinematic mounts that rotate about a center of curvature have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A kinematic mount adjustment mechanism comprising:
a main body having a mounting frame;
a control frame;
a first control screw that contacts a main body surface at an end of the first control screw;
a second control screw oriented orthogonally to the first control screw and that contacts a mounting frame surface at an end of the second control screw;
wherein the mounting frame surface is orthogonal to the main body surface;
wherein the first control screw couples with the control frame by passing through a first screw harness that is coupled with the control frame; and
wherein the second control screw couples with the control frame by passing through a second screw harness that is also coupled with the control frame.

2. The adjustment mechanism of claim 1, wherein the control frame is configured to couple with a kinematic mount.

3. The adjustment mechanism of claim 1, wherein the first and second screw harnesses include internal threading.

4. The adjustment mechanism of claim 1, further comprising a first spring and a second spring, wherein the first spring pulls the control frame toward the main body and wherein the second spring pulls the control frame toward a second spring mount that is affixed to the main body.

5. The adjustment mechanism of claim 4, wherein the first spring is oriented to affect movement caused by turning the first control screw.

6. The adjustment mechanism of claim 4, wherein the second spring is oriented to affect movement caused by turning the second control screw.

7. The adjustment mechanism of claim 1, wherein the main body surface comprises an elongated divot for the end of the first control screw to move within upon turning the second control screw.

8. The adjustment mechanism of claim 1, wherein the mounting frame surface comprises an elongated divot for the end of the second control screw to move within upon turning the first control screw.

9. The adjustment mechanism of claim 1, wherein the first screw harness is moveably coupled with the control frame.

10. A kinematic mount adjustment mechanism comprising:
a main body having a mounting frame;
a control frame;
a first control screw that contacts a main body surface at an end of the first control screw;
a second control screw oriented orthogonally to the first control screw and that contacts a mounting frame surface at an end of the second control screw;
wherein the mounting frame surface is orthogonal to the main body surface;
wherein the first control screw couples with the control frame by passing through a first screw harness that is coupled with the control frame;
wherein the second control screw couples with the control frame by passing through a second screw harness that is also coupled with the control frame;
a first spring that couples with the control frame and with a first spring mount such that the first spring pulls the control frame toward the main body; and
a second spring that couples with the control frame and with a second spring mount that is affixed to the main body such that the second spring pulls the control frame toward the second spring mount.

11. The adjustment mechanism of claim 10, wherein the control frame is configured to couple with a kinematic mount.

12. The adjustment mechanism of claim 10, wherein the first and second screw harnesses include internal threading.

13. The adjustment mechanism of claim 10, wherein the main body surface comprises an elongated divot for the end of the first control screw to move within upon turning the second control screw.

14. The adjustment mechanism of claim 10, wherein the mounting frame surface comprises an elongated divot for the end of the second control screw to move within upon turning the first control screw.

15. The adjustment mechanism of claim 10, wherein the first screw harness is moveably coupled with the control frame.

16. The adjustment mechanism of claim 10, further comprising a countersunk cutout in the main body to facilitate mounting the main body to a surface.
